(19) United States
(12) Patent Application Publication
(10) Pub. No.: US 2009/0070810 A1
(43) Pub. Date: Mar. 12, 2009

(54) METHOD AND APPARATUS FOR OUTPUTTING MEDIA SIGNAL AND METHOD AND APPARATUS FOR TRANSMITTING MEDIA SIGNAL

(75) Inventor: Moon-sang LEE, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/036,353

(22) Filed: Feb. 25, 2008

(30) Foreign Application Priority Data
Sep. 6, 2007 (KR) 10-2007-0090580

(51) Int. Cl. H04N 5/445

(52) U.S. Cl. 725/39; 725/38

(57) ABSTRACT

A method and apparatus for outputting a media signal by performing video muting and a method and apparatus for transmitting a media signal in such a way to allow for video muting. The method of outputting a media signal including at least one of an audio signal and a video signal includes receiving the media signal and an additional information signal regarding the media signal and selectively performing video muting for outputting the media signal from which the video signal is excluded, based on the additional information signal.

### CROSS-REFERENCE TO RELATED PATENT APPLICATION

This application claims priority from Korean Patent Application No. 10-2007-0090580, filed on Sep. 6, 2007, in the Korean Intellectual Property Office, the disclosure of which is incorporated herein in its entirety by reference.

### BACKGROUND OF THE INVENTION

1. Field of the Invention

Methods and apparatuses consistent with the present invention generally relate to outputting a media signal and to transmitting a media signal, and more particularly, to outputting a media signal by performing video muting and transmitting a media signal in such a way to allow for video muting.

2. Description of the Related Art

With the radical development of digital technologies, the world has entered the digital broadcasting age. Digital broadcasting involves the conversion of a conventional analog signal into a digital signal for transmission. In conventional analog broadcasting, only an image can be carried in one electric wave and audio is transmitted through another electric wave. On the other hand, digital broadcasting can transmit a plurality of images or audios through a single electric wave without quality degradation.

As digital broadcasting efficiently uses a transmission channel, the number of broadcasting channels provided to users may greatly increase in the near future where digital broadcasting will be widely spread. The increase in the number of broadcasting channels may lead to a diversification in broadcasting services and exponential increase in digital music broadcasting.

Since a wide screen TV consumes power in proportion to its screen size, it is unnecessary to turn on the TV screen for digital music broadcasting except in special cases where a user needs lyric or album information of a song that is being broadcasted or a music video that is being watched. Also, the lyric or album information may be temporarily output on the TV screen to allow the user to check the lyric or album information, instead of being continuously output on the TV screen.

In conventional analog broadcasting, for a broadcasting signal including only an audio signal without a video signal, the TV screen is turned off However, even for music broadcasting, a broadcasting signal including only an audio signal without a video signal is very unusual. In particular, in the future, for music broadcasting, a background image or a video signal such as lyric information and album information corresponding to a song may also be transmitted together with a music signal. However, in the conventional technique, a video signal is continuously output on the TV screen since the video signal is included in a broadcasting signal, and thereby, resulting in significant power loss.

### SUMMARY OF THE INVENTION

The present invention provides a method and apparatus for outputting a media signal by efficiently performing video muting to save power and a method and apparatus for transmitting a media signal.

According to one aspect of the present invention, there is provided a method of outputting a media signal including at least one of an audio signal and a video signal. The method includes receiving the media signal and an additional information signal regarding the media signal and selectively performing video muting for outputting the media signal from which the video signal is excluded, based on the additional information signal.

The selective performing of video muting may include determining whether the media signal is a signal associated with an audio broadcasting channel based on the additional information signal and performing video muting on the media signal if the media signal is the signal associated with the audio broadcasting channel.

The additional information signal may be an Electronic Program Guide (EPG) signal.

The selective performing of video muting may include performing video muting on the media signal after a lapse of a predetermined amount of time from the output of the media signal including the video signal.

The performing of video muting after the lapse of the predetermined amount of time may include initializing a timer value, incrementing the timer value according to time when the media signal including the video signal is output, and performing video muting on the media signal when the timer value reaches a target value corresponding to the predetermined amount of time.

The performing of video muting after the lapse of the predetermined amount of time may include sensing an external input and performing a control operation to perform at least one of releasing video muting of the media signal, stopping a timer, and initializing the timer value upon the sensing of the external input.

If the external input is a channel switching request signal, the performing of the control operation may include releasing video muting of the media signal and stopping the timer after initialization of the timer value.

The additional information signal may be a control signal for performing video muting on the media signal.

According to another aspect of the present invention, there is provided a method of transmitting a media signal including at least one of an audio signal and a video signal to a user terminal. The method includes generating a control signal for performing video muting on the media signal and transmitting the generated control signal and the media signal to the user terminal, in which video muting is to output the media signal from which the video signal is excluded.

The control signal may function to perform video muting on the media signal after a lapse of a predetermined amount of time from the receipt of the control signal by the user terminal.

According to another aspect of the present invention, there is provided an apparatus for outputting a media signal comprising at least one of audio signal and a video signal. The apparatus includes a reception unit receiving the media signal and an additional information signal regarding the media signal, an output unit outputting the received media signal, and a video muting unit performing video muting for outputting the media signal from which the video signal is excluded to the output unit based on the additional information signal.

According to another aspect of the present invention, there is provided an apparatus for transmitting a media signal including at least one of an audio signal and a video signal to a user terminal. The apparatus includes a signal generation unit generating a control signal for performing video muting on the media signal and a transmission unit transmitting the generated control signal and the media signal to the user terminal, in which video muting is to output the media signal from which the video signal is excluded.

### BRIEF DESCRIPTION OF THE DRAWINGS

The above and other features and advantages of the present invention will become more apparent by describing in detail an exemplary embodiment thereof with reference to the attached drawings in which:

FIG. 1 is a block diagram of an apparatus for outputting a media signal, according to an exemplary embodiment of the present invention;

FIG. 2 is a detailed block diagram of a video muting unit according to an exemplary embodiment of the present invention;

FIGS. 3A through 3E are diagrams for explaining an example of video muting according to an exemplary embodiment of the present invention;

FIG. 4 is a block diagram of an apparatus for transmitting a media signal, according to an exemplary embodiment of the present invention;

FIG. 5 is a flowchart illustrating a method of outputting a media signal according to an exemplary embodiment of the present invention; and

FIG. 6 is a flowchart illustrating a method of transmitting a media signal according to an exemplary embodiment of the present invention.

### DETAILED DESCRIPTION OF EXEMPLARY EMBODIMENTS OF THE INVENTION

Hereinafter, an exemplary embodiment of the present invention will be described in detail with reference to the accompanying drawings. It should be noted that like reference numerals refer to like elements illustrated in one or more of the drawings. In the following description of the present invention, detailed description of known functions and configurations incorporated herein will be omitted for conciseness and clarity.

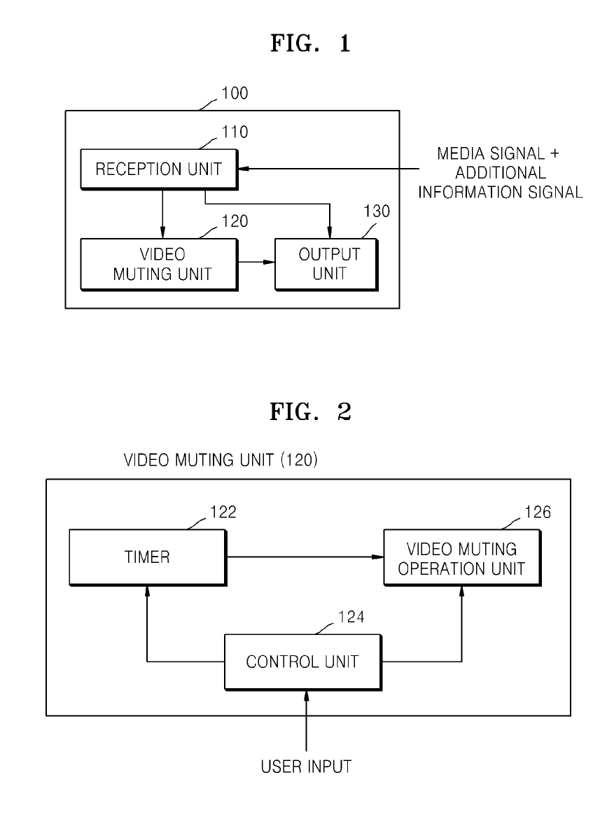

FIG. 1 is a block diagram of an apparatus 100 for outputting a media signal according to an exemplary embodiment of the present invention.

Referring to FIG. 1, the apparatus 100 outputs a media signal including at least one of an audio signal and a video signal, and includes a reception unit 110, a video muting unit 120, and an output unit 130.

The reception unit 110 receives a media signal and an additional information signal regarding the media signal. The media signal received by the reception unit 110 may vary in forms. For example, the media signal may be a broadcasting signal transmitted from a broadcasting server. Herein, the media signal is assumed to be a broadcasting signal. However, the media signal is not limited to a broadcasting signal.

The additional information signal regarding the media signal may be an EPG signal. The EPG signal is used when the media signal is a digital broadcasting signal and to transmit information about the digital broadcasting signal using an empty frequency band or a surplus channel. By using the EPG signal, a user can check a schedule of broadcasting programs provided by a broadcasting station or obtain detailed information about a desired broadcasting program.

The output unit 130 outputs the media signal received by the reception unit 110. The output unit 130 may include a display unit for outputting a video signal included in the media signal and a speaker unit for outputting an audio signal included in the media signal. The output unit 130 may output a media signal including both a video signal and an audio signal or a media signal from which a video signal is excluded based on a control signal from the video muting unit 120.

The video muting unit 120 selectively performs video muting in order to output a media signal from which a video signal is excluded, based on the additional information signal. Herein, video muting means outputting a media signal from which a video signal is excluded when the media signal including at least one of the video signal and an audio signal is output.

The video muting unit 120 determines whether to output a video signal included in the received media signal based on the additional information signal and performs video muting on the received media signal if the video muting unit 120 determines that it is unnecessary to output the video signal included in the received media signal. For such determination, the video muting unit 120 may preset a criterion for the determination and compare the preset criterion with the additional information signal.

For example, the video muting unit 120 may be set to perform video muting on a media signal when the media signal is a signal associated with an audio broadcasting channel. Determination of whether the media signal is a signal associated with an audio broadcasting channel can be made based on the additional information signal. Herein, the signal associated with the audio broadcasting channel means a broadcasting signal used in audio broadcasting. If the additional information signal is an EPG signal, it can be determined whether the received media signal is the signal associated with the audio broadcasting channel using the EPG signal. If the received media signal is the signal associated with the audio broadcasting channel, it is unnecessary to output a video signal and thus the video muting unit 120 performs video muting on the received media signal.

In another example, if the additional information signal is a control signal for performing video muting on the received media signal in a user terminal, the video muting unit 120 performs video muting on the media signal according to the control signal. The control signal may be implemented as an application program, which may be written in the Java language, for controlling a display window of the user terminal, and the user terminal may receive the application program through a data stream output from a broadcasting station. The user terminal receives the application program and executes the received application program, thereby performing video muting on the received media signal. The application program may contain information about a point in time at which video muting is to be performed on the media signal.

For example, video muting may be performed after 30 seconds from the execution of the application program in the user terminal. In this case, a timer indicating the lapse of time may be programmed in the application program. If a user input occurs prior to the lapse of 30 seconds from the execution of the application program, the timer is initialized. If the user input does not occur until the lapse of 30 seconds from the execution of the application program, video muting is performed on the received signal. If the user input occurs after video muting, video muting may be released and the timer may be initialized. If the user input does not occur for 30 seconds after the initialization of the timer, video muting may be performed again. On the other hand, if the user input is a channel switching signal, the timer may be stopped and the application program may be terminated.

The video muting unit 120 may output a media signal including a video signal and perform video muting on the media signal after the lapse of predetermined time from the output of the media signal. Video muting on the media signal after the lapse of predetermined time will be described in detail with reference to FIG. 2.

FIG. 2 is a detailed block diagram of the video muting unit 120 according to an exemplary embodiment of the present invention.

Referring to FIG. 2, the video muting unit 120 includes a timer 122, a control unit 124, and a video muting operation unit 126.

The timer 122 increments a timer value according to time when the media signal including the video signal is output to the output unit 130.

The control unit 124 initializes the timer 122 upon receipt of the media signal.

The video muting operation unit 126 performs video muting on the media signal when the timer value reaches a predetermined target value.

Hereinafter, it is assumed that the media signal is the signal associated with the audio broadcasting channel according to the determination based on the additional information signal and video muting is performed on the media signal.

The control unit 124 initializes the timer 122 to a timer value may be ‘0’.

The timer 122 increments the timer value according to the time the media signal is output. In other words, when the media signal is output for ‘10’ seconds, the timer value is incremented to ‘10’. The media signal including the video signal may be output until the timer value of the timer 122 reaches the predetermined target value.

The video muting operation unit 126 performs video muting on the media signal if the timer value of the timer 122 reaches the predetermined target value. In other words, the video muting operation unit 126 outputs the received media signal while excluding the video signal from the media signal. The predetermined target value may change according to a point in time at which video muting is to be performed. For example, when video muting is to be performed on the media signal after ‘30’ seconds from reproduction of the media signal and the timer value of the timer 122 is incremented by ‘1’ for ‘1’ second during which the media signal is reproduced, the predetermined target value may be set to ‘30’.

The video muting unit 120 may further include an input sensing unit (not shown) that senses an external input, and the control unit 124 performs a predetermined operation according to the external input that may be sensed by user manipulation of a user interface such as a remote control, and a button and a touch screen attached to a user terminal.

The control unit 124 performs a control operation such that at least one of releasing video muting of the media signal, stopping the timer 122, and initializing the timer value is performed according to the external input. Herein, releasing video muting of a media signal including at least one of an audio signal and a video signal means terminating video muting and outputting the media signal including the video signal to the output unit 130.

For example, when the user desires to increase or reduce the volume or change output settings, the control unit 124 performs a control operation in order to release video muting of the media signal and at the same time, to initialize the timer value of the timer 122. In other words, if the user increases or reduces the volume or changes output settings, the video muting operation unit 126 releases video muting in order to allow the user to check a user manipulation state. However, if a user input is stopped, it is desirable to resume video muting of the media signal again. In this case, if the initialized timer value reaches the predetermined target value again, the video muting operation unit 126 resumes video muting of the media signal.

In another example, when the video signal has to be output for a relatively long period of time, as when the user desires to use a caption function in order to view the lyrics of a song, the control unit 124 performs a control operation in order to release video muting of the media signal, initialize the timer value of the timer 122, and stop the timer 122. When the user needs to watch the video signal for a relatively long period of time, the timer 122 may be entirely stopped in order to avoid disturbing the watching of video by the user. In this case, the video signal included in the media signal is continuously output to the output unit 130 unless the user separately instructs the control unit 124 to perform video muting on the media signal.

In another example, if the user switches a channel, the control unit 124 performs a control operation in order to release video muting of the media signal, initialize the timer value of the timer 122, and stop the timer 122. When the channel is switched to another audio broadcasting channel, the timer 122 may resume its operation upon receipt of a media signal associated with the switched channel. If an external input does not occur for a predetermined amount of time after reception of the media signal associated with the switched channel and thus the timer value reaches the predetermined target value, the video muting operation unit 126 performs video muting on the media signal associated with the switched channel.

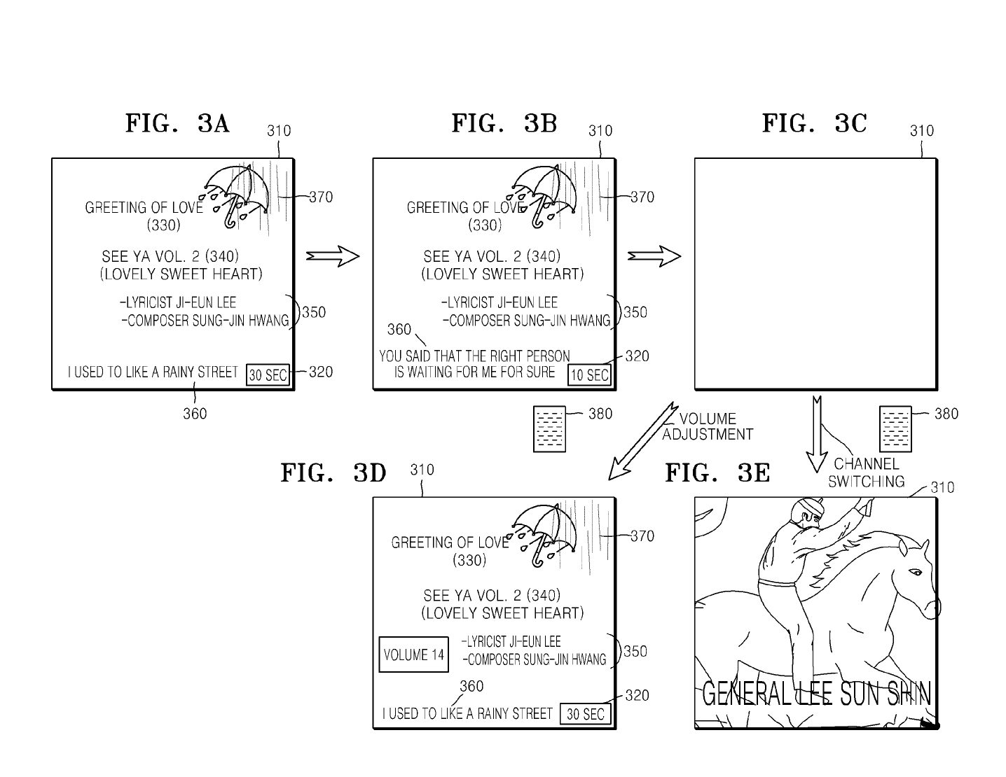

FIGS. 3A through 3E are diagrams for explaining an example of video muting according to an exemplary embodiment of the present invention.

Referring to FIG. 3A, a user terminal 310 outputs a media signal associated with an audio broadcasting channel.

The media signal includes both a video signal and an audio signal. In the current exemplary embodiment of the present invention, the video signal includes a title 330, album information 340, lyricist and composer information 350, lyrics 360, and a background video signal 370.

The media signal is a signal associated with an audio broadcasting channel and is subject to video muting by means of the video muting unit 120. In the current exemplary embodiment of the present invention, it is assumed that video muting is performed after the lapse of ‘30’ seconds from the output of the media signal.

The control unit 124 initializes a timer value 320 upon receipt of the media signal. Thus, the timer value 320 is initialized to ‘30’. This means that ‘30’ seconds are left until video muting of the media signal. The timer value 320 may not be output in the user terminal 310 and may be initialized to ‘0’. When the timer value 320 is initialized to ‘0’, video muting is performed when the timer value 320 reaches ‘30’. Even though the timer value 320 is initialized upon receipt of the media signal in the current exemplary embodiment of the present invention, the timer value 320 may also be initialized upon first output of the received media signal on the user terminal 310.

Referring to FIG. 3B, the media signal has been reproduced for ‘20’ seconds from initialization of the timer value 320. Thus, the current timer value 320 is ‘10’, and this means that ‘10’ seconds are left until video muting of the media signal.

Referring to FIG. 3C, the media signal has been reproduced for ‘30’ seconds from initialization of the timer value 320. Thus, the timer value 320 reaches the predetermined target value ‘0’ and the video muting operation unit 126 performs video muting on the media signal. Once video muting is performed on the media signal, the video signal is not output to the user terminal 310. However, the other signals included in the media signal such as the audio signal may still be output to the user terminal 310. In this case, the audio signal may be output through a speaker attached to the user terminal 310.

Referring to FIG. 3D, the user adjusts the volume using a remote control 380. As the user adjusts the volume, the input sensing unit (not shown) senses an external input. The control unit 124 performs a control operation to release video muting of the media signal, so as to cause the video signal to be output to the user terminal 310. In the current exemplary embodiment of the present invention, the external input is user volume adjustment and thus it is unnecessary to output the video signal for a long period of time. Thus, the control unit 124 performs a control operation to initialize the timer value 320 of the timer 122. After the lapse of a predetermined amount time from the initialization of the timer value 320 of the timer 122, the video muting operation unit 126 performs video muting on the media signal. In other words, the timer value 320 is initialized to ‘30’ and the video muting operation unit 126 resumes video muting of the media signal if a user input does not occur within the ‘30’ seconds.

Referring to FIG. 3E, the user switches a channel using the remote control 380. As the user switches the channel, the input sensing unit (not shown) senses an external input. The control unit 124 performs a control operation to release video muting of the media signal, so as to cause the video signal to be output to the user terminal 310. At the same time, the control unit 124 performs a control operation to stop the timer 122. In the current exemplary embodiment of the present invention, the switched channel is a broadcasting channel of a drama show and the video signal included in the media signal has to be output. Thus, the output unit 130 outputs the media signal associated with the switched channel, which includes the video signal, to the user terminal 310 without performing video muting on the media signal.

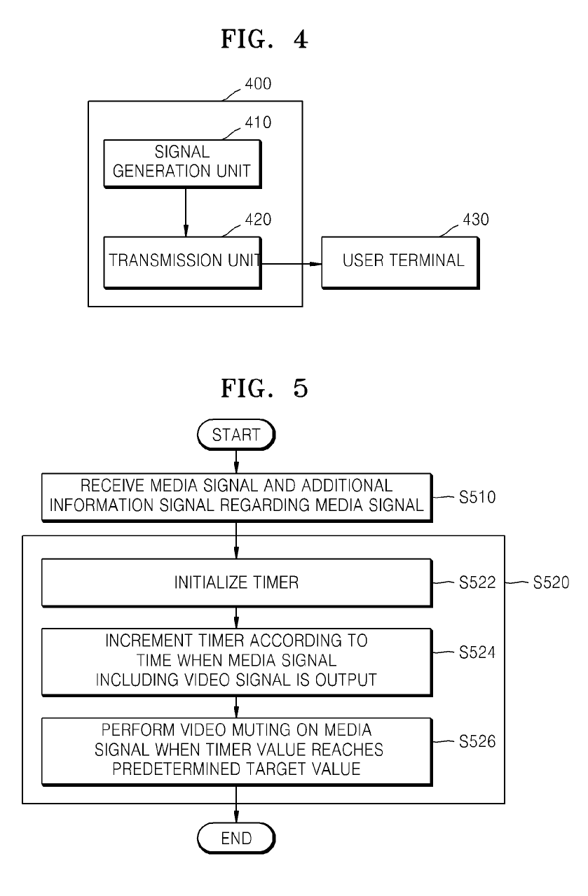

FIG. 4 is a block diagram of an apparatus 400 for transmitting a media signal, according to an exemplary embodiment of the present invention.

Referring to FIG. 4, the apparatus 400 transmits a media signal including at least one of a video signal and an audio signal, and includes a signal generation unit 410 and a transmission unit 420.

The signal generation unit 410 generates a control signal for performing video muting of the media signal in a user terminal 430. Herein, video muting means outputting a media signal from which a video signal is excluded when the media signal including at least one of the video signal and an audio signal is output.

The control signal generated by the signal generation unit 410 may be an application program, which may be written in the Java language, for performing video muting on the media signal in the user terminal 430.

The transmission unit 420 transmits the generated control signal and the media signal to the user terminal 430. The control signal may be inserted into data transmitted to the user terminal 430 and may be transmitted repetitively at predetermined time intervals. The user terminal 430 receives the application program as the control signal transmitted repetitively at predetermined time intervals and executes the received application program.

The control signal may contain information about a point in time at which video muting is to be performed on the media signal. For example, video muting may be performed on the media signal after a lapse of ‘30’ seconds from the execution of the application program in the user terminal 430. Once an external input is sensed, the point in time for video muting may be delayed or video muting may be released and the execution of the application program may be terminated according to the type of the sensed external input.

For example, if the user changes settings such as the volume when video muting is not yet being performed, a timer may be initialized using the application program in order to delay the point in time for video muting. If the user changes settings such as the volume when video muting is already being performed, video muting may be released and resumed after the lapse of a predetermined amount of time.

In another example, when the user switches a channel, video muting is released and the application program used in the previous channel is terminated. However, if the channel is switched to another audio broadcasting channel, video muting may be performed using a newly received application program.

If the user desires to release video muting like when the user desires to use a caption function, the timer may be initialized and stopped in order to temporarily stop the execution of the application program until an external input for resuming video muting occurs.

FIG. 5 is a flowchart illustrating a method of outputting a media signal according to an exemplary embodiment of the present invention. Herein, the media signal includes at least one of an audio signal and a video signal.

In operation S510, a media signal and an additional information signal regarding the media signal are received.

In operation S520, video muting, for outputting the media signal from which the video signal is excluded, is selectively performed based on the additional information signal. For example, it is determined whether the media signal is a signal associated with an audio broadcasting channel based on the additional information signal and video muting may be performed on the media signal if the media signal is the signal associated with the audio broadcasting channel.

In operation S520, video muting may be performed on the media signal after the lapse of a predetermined amount of time from the output of the media signal including the video signal. In this case, operation S520 may comprise operations S522 through S526.

In operation S522, a timer is initialized.

In operation S524, a timer value of the timer is incremented according to the time when the media signal including the video signal is output.

In operation S526, when the timer value reaches a predetermined target value, video muting is performed on the media signal.

The method of outputting a media signal according to the present embodiment of the present invention may further include an operation of sensing an external input. Once the external input is sensed, at least one of releasing video muting of the media signal, stopping the timer, and initializing the timer value is performed according to the external input.

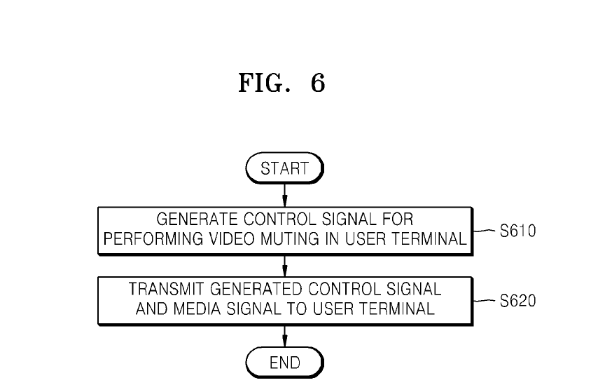

FIG. 6 is a flowchart illustrating a method of transmitting a media signal according to an exemplary embodiment of the present invention

In operation S610, a control signal for performing video muting on a media signal including at least one of a video signal and an audio signal in a user terminal is generated. The control signal may function to perform video muting on the media signal after the lapse of a predetermined amount of time from the receipt of the control signal by the user terminal.

In operation S620, the generated control signal and the media signal are transmitted to the user terminal.

As described above, according to an exemplary embodiment of the present invention, by performing video muting on a media signal based on an additional information signal regarding the media signal, video muting can be performed dynamically according to the media signal.

Moreover, power consumption by the user terminal can be reduced due to efficient video muting.

The present invention can also be embodied as a program that can be implemented on a computer and a general-purpose digital computer executing the program using a computer-readable recording medium. Examples of the computer readable recording medium include magnetic recording media such as read-only memory (ROM), random-access memory (RAM), floppy disks, and hard disks, optical data storage devices such as CD-ROMs and digital versatile disks (DVDs), and carrier waves such as transmission over the Internet.

While the present invention has been particularly shown and described with reference to an exemplary embodiment thereof, it will be understood by one of ordinary skill in the art that various changes in form and detail may be made therein without departing from the spirit and scope of the present invention as defined by the accompanying claims.

What is claimed is:

1. A method of outputting a media signal comprising at least one of an audio signal and a video signal, the method comprising:
receiving the media signal and an additional information signal regarding the media signal; and
selectively performing video muting for outputting the media signal from which the video signal is excluded, based on the additional information signal.

2. The method of claim 1, wherein the selective performing of video muting comprises:
determining whether the media signal is a signal associated with an audio broadcasting channel based on the additional information signal; and
performing video muting on the media signal if the media signal is the signal associated with the audio broadcasting channel.

3. The method of claim 2, wherein the additional information signal is an Electronic Program Guide (EPG) signal.

4. The method of claim 1, wherein the selective performing of video muting comprises performing video muting on the media signal after a lapse of a predetermined amount of time from the output of the media signal including the video signal.

5. The method of claim 4, wherein the performing of video muting after the lapse of the predetermined amount of time comprises:
initializing a timer value;
incrementing the timer value according to time when the media signal including the video signal is output; and
performing video muting on the media signal when the timer value reaches a target value corresponding to the predetermined amount of time.

6. The method of claim 5, wherein the performing of video muting after the lapse of the predetermined amount of time comprises:
sensing an external input; and
performing a control operation to perform at least one of releasing video muting of the media signal, stopping a timer, and initializing the timer value upon the sensing of the external input.

7. The method of claim 6, wherein if the external input is a channel switching request signal, the performing of the control operation comprises releasing video muting of the media signal and stopping the timer after initialization of the timer value.

8. The method of claim 1, wherein the additional information signal is a control signal for performing video muting on the media signal.

9. A method of transmitting a media signal including at least one of an audio signal and a video signal to a user terminal, the method comprising:
generating a control signal for performing video muting on the media signal; and
transmitting the generated control signal and the media signal to the user terminal,
wherein the video muting is to output the media signal from which the video signal is excluded.

10. The method of claim 9, wherein the control signal functions to perform video muting on the media signal after a lapse of a predetermined amount of time from the receipt of the control signal by the user terminal.

11. An apparatus for outputting a media signal comprising at least one of an audio signal and a video signal, the apparatus comprising:
a reception unit which receives the media signal and an additional information signal regarding the media signal;
an output unit which outputs the received media signal; and
a video muting unit which performs video muting for outputting the media signal from which the video signal is excluded to the output unit based on the additional information signal.

12. The apparatus of claim 11, wherein the video muting unit determines whether the media signal is a signal associated with an audio broadcasting channel based on the additional information signal and performs video muting on the media signal when the media signal is the signal associated with the audio broadcasting channel.

13. The apparatus of claim 12, wherein the additional information signal is an Electronic Program Guide (EPG) signal.

14. The apparatus of claim 11, wherein the video muting unit performs video muting on the media signal after a lapse of a predetermined amount of time from the output of the media signal including the video signal.

15. The apparatus of claim 14, wherein the video muting unit comprises:
a timer which increments a timer value according to time when the media signal including the video signal is output;
a control unit which performs a control operation to initialize the timer value upon receipt of the media signal; and
a video muting operation unit which performs video muting on the media signal when the timer value reaches a target value corresponding to the predetermined amount of time.

16. The apparatus of claim 15, wherein the video muting unit further comprises an input sensing unit which senses an external input, and the control unit performs a control operation to perform at least one of releasing video muting of the media signal, stopping the timer, and initializing the timer value upon the sensing of the external input.

17. The apparatus of claim 16, wherein when the external input is a channel switching request signal, the control unit performs a control operation to release video muting of the media signal and stop the timer after initialization of the timer value.

18. The apparatus of claim 11, wherein the additional information signal is a control signal for performing video muting on the media signal.

19. An apparatus for transmitting a media signal including at least one of an audio signal and a video signal to a user terminal, the apparatus comprising:
a signal generation unit which generates a control signal for performing video muting on the media signal; and
a transmission unit which transmits the generated control signal and the media signal to the user terminal,
wherein the video muting is to output the media signal from which the video signal is excluded.

20. The apparatus of claim 19, wherein the control signal functions to perform video muting on the media signal after a lapse of a predetermined amount of time from the receipt of the control signal by the user terminal.

21. A computer-readable recording medium having recorded thereon a program for executing a method of outputting a media signal comprising at least one of an audio signal and a video signal, the method comprising:
receiving the media signal and an additional information signal regarding the media signal; and
selectively performing video muting for outputting the media signal from which the video signal is excluded, based on the additional information signal.
